(19) United States
(12) Patent Application Publication
(10) Pub. No.: US 2026/0305626 A1
(43) Pub. Date: Oct. 8, 2026

(54) LOW NET CARB HARD TORTILLA SHELL AND METHOD OF PREPARATION

(71) Applicant: GENERAL MILLS, INC., Minneapolis, MN (US)

(72) Inventors: Jose Daniel Estrada Andino, Roseville, MN (US); John James Fenske, Shoreview, MN (US); Lindsey Golinski, Champlin, MN (US); Eric T. Gugger, Plymouth, MN (US)

(73) Assignee: GENERAL MILLS, INC., Minneapolis, MN (US)

(21) Appl. No.: 19/483,426

(22) PCT Filed: May 9, 2024
(86) PCT No.: PCT/US2024/028481

§ 371 Date: Nov. 11, 2025

Related U.S. Application Data
(60) Provisional application No. 63/465,677, filed on May 11, 2023.

(51) Int. Cl. A21D 13/42; A21D 13/02; A21D 13/047; A21D 13/06; A21D 13/60

(52) U.S. Cl. CPC A21D 13/42; A21D 13/02; A21D 13/047; A21D 13/06; A21D 13/60

(57) ABSTRACT

A shelf stable hard tortilla shell includes a type 4 resistant starch (“RS4”) ingredient, a soluble fiber, a fine corn bran, and corn masa. The shelf stable tortilla shell has a net carbohydrate content of less than 25% by weight of the tortilla shell and a moisture content of about 3% to about 11% by weight of the tortilla shell. The shelf stable tortilla shell optionally includes a fold support composition, coarse corn bran, and/or oil. A method of making a shelf stable tortilla shell includes providing a dough, forming the dough into a sheet and cooking (e.g., baking and/or frying) the sheet to form a hard taco shell, tostada or chip. The method can include gelatinizing at least some of the starch in the corn masa or in the corn bran.

### CROSS-REFERENCE TO RELATED APPLICATION

This application claims the benefit of U.S. Provisional Application No. 63/465,677, filed May 11, 2023.

### FIELD OF THE INVENTION

The invention generally pertains to food products and methods of preparing food products. More particularly, the invention is related to a hard tortilla shell that has a low net carbohydrate content (“low net carb”), as well as methods for preparing a low net carb tortilla shell.

### BACKGROUND OF THE INVENTION

Net carbohydrate content (“net carbs”) refers to the amount of carbohydrates considered to be actually digested by a consumer and have an impact on blood sugar levels. Net carbs are calculated by subtracting the fiber content and sugar alcohol content from the total carbohydrate content. There is consumer demand for foods with low net carbohydrate content due to certain health trends (e.g., the Atkins diet). There is also a demand for foods that contain a high level of total dietary fiber, e.g., for colon health and for potential cholesterol reducing benefits. Regardless of these known demands, there is still seen to exist a need for a hard tortilla shell with low net carbs for consumers.

### SUMMARY OF THE INVENTION

As used herein, hard tortilla shells encompass taco shells, tostados and even chips. A shelf stable hard tortilla shell according to the invention includes a type 4 resistant starch (“RS4”) ingredient, a soluble fiber, a fine corn bran, corn masa, and optionally, a coarse corn bran. The RS4 ingredient is present in an amount of about 20% to about 40% by dry weight of the tortilla shell and can comprise a modified corn starch, a modified wheat starch, a modified tapioca starch, a modified potato starch, or any combination thereof. The soluble fiber is present in an amount of about 5% to about 20% by dry weight of the tortilla shell and can comprise soluble corn fiber. The fine corn bran is present in an amount of about 15% to about 52% by dry weight of the tortilla shell and comprises particles, wherein at least 80% by weight of the particles of the fine corn bran pass through a #100 mesh sieve. The optional coarse corn bran can be present in an amount of up to about 20% by dry weight of the tortilla shell and comprises particles, wherein at least 70% by weight of the particles of the coarse corn bran are retained on a #100 mesh sieve. The corn masa is present in an amount of about 12% to about 25% by dry weight of the tortilla shell. Optionally, the corn masa is pre-cooked or at least some of the starch in the corn masa is gelatinized (e.g., using warm water “no-cook” gelatinizing as described below).

The shelf stable hard tortilla shell has a net carbohydrate content of less than 25% (e.g., about 10% to about 24%) by weight of the tortilla shell and a moisture content of about 3% to about 11% (e.g., of about 4% to about 10%) by weight of the tortilla shell. In certain embodiments, the shelf stable tortilla shell also includes a fold support composition in an amount of up to 5% by dry weight of the tortilla shell.

A shelf stable hard tortilla shell can optionally contain oil in an amount of up to 25% by weight.

A method of making a shelf stable tortilla shell includes providing a dough, forming the dough into a sheet and cooking (e.g., baking and/or frying) the sheet to a moisture of about 3% to about 11% by weight of the sheet to form the tortilla shell, wherein the tortilla shell has a net carbohydrate content of less than 25% by weight of the tortilla shell. The dough includes a type 4 resistant starch (“RS4”) ingredient, a soluble fiber, a fine corn bran, corn masa, and water. The water is present in an amount of about 40% to about 55% by weight of the dough and can be warm (e.g., have a temperature of about 25° C. (77° F.) to about 55° C. (131° F.)), to provide a “no-cook” gelatinizing of at least some of the starch in the corn masa.

The step of forming the dough into a sheet can include forming the sheet into a U-shape. In some embodiments, the dough sheet is formed into a U-shape during frying.

In certain embodiments, the method of making a shelf stable tortilla shell includes gelatinizing at least a portion of a starch content in the fine corn bran and/or the coarse corn bran (“cook method,” compared to “no-cook” mentioned above). This step of gelatinizing can be performed at a temperature of at least 87.8° C. (190° F.).

### DETAILED DESCRIPTION OF EMBODIMENTS

Initially, it should be noted that the embodiments of the present invention described below are not intended to be exhaustive or limit the invention to the precise forms disclosed in the following detailed description. Rather, a purpose of the embodiments chosen and described is so that the appreciation and understanding by others skilled in the art of the principles and practices of the present invention can be facilitated.

In interpreting the present description, it is to be understood that the invention is concerned with making a hard tortilla shell and this term encompasses hard taco shells (such as U-shaped taco shells, flat bottom shells and taco bowls), tostados and chips (e.g., flat, curved or bowl-shaped chips). Unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

A shelf stable hard tortilla shell that is low in net carbs (“low net carb hard tortilla shell”) has been developed. By “low net carb” it is meant a net carbohydrate content of less than 25% (e.g., about 10% to about 24%) by weight. The tortilla shell is a hard, cooked dough product (e.g., baked or fried) that is typically sized to be hand-held. The hard tortilla shell can take various forms, such as a hard taco shell (e.g., a U-shape) filled with various ingredients such as seasoned ground beef, cheese and lettuce. In contrast to a flexible soft tortilla that may also be used to make a taco, the hard shell of the invention has a set shape and a crunchy bite. As with conventional hard tortilla shells on the market, the hard tortilla shell of the present invention can be eaten as-is, without further processing by the consumer. A shelf stable hard tortilla shell of the present invention includes a type 4 resistant starch (“RS4”) ingredient, a soluble fiber, a fine corn bran, a coarse corn bran and corn masa.

The RS4 ingredient is present in an amount of about 20% to about 40% (e.g., about 28% to about 38%, or about 30% to about 35%) by dry weight of the tortilla shell and has an RS4 content of at least 75% by weight of the RS4 ingredient. Resistant starches are prebiotic dietary fibers that are non-digestible in the small intestine. RS4 is a subcategory of resistant starches and are starches chemically modified typically through esterification, cross-linking, or transglycosylation. The RS4 ingredient can comprise a modified corn starch, a modified wheat starch, a modified tapioca starch, a modified potato starch, or any combination thereof.

As used herein, the term “dry weight” refers to weight of a component exclusive of moisture and oil content. A hard tortilla shell provided herein is typically cooked (e.g., by baking and/or frying), and oil can be used during the cooking process to help promote a desired flavor, texture, and/or appearance. Thus, in some cases, a hard tortilla can contain up to 25% (e.g., about 10% to about 25%) by weight oil that is not considered part of the dry weight herein, especially if the tortilla is fried.

The soluble fiber is present in an amount of about 5% to about 20% (e.g., of about 7% to about 10%) by dry weight of the tortilla shell. In preferred embodiments, the soluble fiber is present in an amount of about 5% to about 12% by dry weight of the tortilla shell. The soluble fiber can comprise soluble corn fiber (e.g., soluble corn fiber in an amount of about 7% to about 10% by dry weight of the tortilla shell).

The fine corn bran is present in an amount of about 15% to about 52% (e.g., about 30% to about 45%; about 22% to about 40%; preferably, about 25% to about 38%) by dry weight of the tortilla shell. The fine corn bran comprises particles, wherein at least 80% by weight of the particles of the fine corn bran pass through a #100 mesh sieve (i.e., a sieve having 100 openings per inch; openings of approximately 149 microns). In some embodiments, at least 25% (e.g., at least 50%) by weight of the particles of the fine corn bran pass through a #200 mesh sieve (i.e., a sieve having 200 openings per inch; openings of approximately 74 microns). In some embodiments, the fine corn bran can be ultrafine corn bran (i.e., particles less than 0.1 micron).

In some embodiments, a coarse corn bran can be included in a tortilla shell. The coarse corn bran is present in an amount of up to about 20% (e.g., about 5% to about 12%; preferably, about 5% to about 10%) by dry weight of the tortilla shell. The coarse corn bran comprises particles, wherein at least 70% by weight of the particles of the coarse corn bran are retained on a #100 mesh sieve. In some embodiments, at least 50% by weight of the particles of the coarse corn bran are retained on a #80 mesh sieve (i.e., a sieve having 80 openings per inch; openings of approximately 177 microns).

The corn masa is present in an amount of about 12% to about 25% (e.g., about 13% to about 20%) by dry weight of the tortilla shell. Optionally, the corn masa is pre-cooked or at least some of the starch in the corn masa is gelatinized (e.g., using warm water “no-cook” gelatinizing as described below).

The shelf stable tortilla shell has a net carbohydrate content of less than 25% (e.g., about 10% to about 24%) by weight of the tortilla shell and a moisture content of about 3% to about 11% (e.g., of about 4% to about 10%) by weight of the tortilla shell. In some embodiments, the tortilla shell is gluten-free.

In certain embodiments, the shelf stable tortilla shell also includes a fold support composition in an amount of up to 5% by dry weight of the tortilla shell. The fold support composition supports flexibility for folding into a set shape (e.g., a U-shape taco shell, a flat bottom taco shell or a taco bowl) and includes a pregelatinized starch source in an amount of up to 4% (preferably, up to 3%) by dry weight of the tortilla shell, xanthan gum in an amount of up to 3% (preferably, up to 2%) by dry weight of the tortilla shell, and/or carboxymethylcellulose in an amount of up to 2% (preferably, up to 1.5%) by dry weight of the tortilla shell. In some embodiments, the tortilla shell consists of the RS4 ingredient, soluble corn fiber, fine corn bran, corn masa, a flavorant in an amount of up to 3% by dry weight of the tortilla shell, oil in an amount of up to 25% by weight, moisture in an amount of up to 11% by weight, and the fold support composition.

A method of making a shelf stable tortilla shell includes providing a dough, forming the dough into a sheet and cooking the sheet to a moisture of about 3% to about 11% by weight of the sheet to form the tortilla shell. The tortilla shell has a net carbohydrate content of less than 20% by weight of the tortilla shell. The dough includes a type 4 resistant starch (“RS4”) ingredient, a soluble fiber, a fine corn bran, corn masa and water.

The RS4 ingredient is present in an amount of about 20% to about 40% (e.g., of about 28% to about 38%, or about 30% to about 35%) by dry weight of the dough and has an RS4 content of at least 75% by weight of the RS4 ingredient. The RS4 ingredient can comprise a modified corn starch, a modified wheat starch, a modified tapioca starch, a modified potato starch, or any combination thereof.

The soluble fiber is present in an amount of about 5% to about 20% (e.g., of about 7% to about 10%) by dry weight of the dough. In preferred embodiments, the soluble fiber is present in an amount of about 5% to about 12% by dry weight of the dough. The soluble fiber can comprise soluble corn fiber (e.g., soluble corn fiber in an amount of about 7% to about 10% by dry weight of the dough).

The fine corn bran is present in an amount of about 15% to about 52% (e.g., about 30% to about 45%; about 22% to about 40%; preferably, about 25% to about 38%) by dry weight of the dough. The fine corn bran comprises particles, wherein at least 80% by weight of the particles of the fine corn bran pass through a #100 mesh sieve. In some embodiments, at least 25% by weight of the particles of the fine corn bran pass through a #200 mesh sieve. In some embodiments, the fine corn bran can be ultrafine corn bran.

In embodiments where coarse corn bran is included, the coarse corn bran is present in an amount of up to about 20% (e.g., about 5% to about 12%; preferably, about 5% to about 10%) by dry weight of the dough. The coarse corn bran comprises particles, wherein at least 70% by weight of the particles of the coarse corn bran are retained on a #100 mesh sieve. In some embodiments, at least 50% by weight of the particles of the coarse corn bran are retained on a #80 mesh sieve.

The corn masa is present in an amount of about 12% to about 25% (e.g., about 13% to about 25% or about 15% to about 20%) by dry weight of the dough. Optionally, the corn masa is pre-cooked or at least some of the starch in the corn masa is gelatinized (e.g., using warm water “no-cook” gelatinizing as described below).

Water is present in an amount of about 40% to about 55% by weight of the dough. The water can be warm (e.g., have a temperature of about 25° C. (77° F.) to about 55° C. (131° F.)or a temperature of about 38° C. (100° F.) to about 50° C. (122° F.)), to provide a “no-cook” gelatinizing of at least some of the starch in the corn masa.

The step of forming the dough into a sheet can include forming the sheet into a particular shape. For example, the sheet can be formed to make a taco shell having a U-shape or a taco bowl. In some embodiments, the sheet is cooked to an intermediate moisture of from about 20% to about 30% by weight. Cooking can include baking the sheet and/or frying the sheet. In some embodiments, the dough sheet is formed into a particular shape during frying.

In some embodiments, the method of making a shelf stable tortilla shell includes gelatinizing at least a portion of a starch content in the fine corn bran and/or the coarse corn bran (“cook method,” compared to “no-cook” mentioned above). This step of gelatinizing can be performed at a temperature of at least 87.8° C. (190° F.).

Optionally, the dough includes a fold support composition in an amount of up to 5% by dry weight of the dough to support flexibility for folding into a set shape (e.g., a U-shape). The fold support composition includes a pregelatinized starch source in an amount of up to 4% by dry weight of the dough (preferably, up to 3%), a xanthan gum in an amount of up to 3% by dry weight of the dough (preferably, up to 2%) and/or carboxymethylcellulose in an amount of up to 2% by dry weight of the dough (preferably, up to 1.5%). The pregelatinized starch source can supplement the “no-cook” gelatinizing of at least some of the starch in the corn masa achieved by warm water in the dough (mentioned above).

1. A shelf stable tortilla shell, comprising:
a. a type 4 resistant starch (RS4) ingredient in an amount of about 20% to about 40% by dry weight of the tortilla shell, the RS4 ingredient having an RS4 content of at least 75% by weight of the RS4 ingredient;
b. a soluble fiber in an amount of about 5% to about 20% by dry weight of the tortilla shell;
c. a fine corn bran in an amount of about 15% to about 52% by dry weight of the tortilla shell, the fine corn bran comprising particles, wherein at least 80% by weight of the particles of the fine corn bran pass through a #100 mesh sieve;
d. corn masa in an amount of about 12% to about 25% by dry weight of the tortilla shell;
e. a net carbohydrate content of less than 25% by weight of the tortilla shell;
f. oil in an amount of up to about 25% by weight; and
g. a moisture content of about 3% to about 11% by weight of the tortilla shell.

2. The tortilla shell of claim 1, wherein the RS4 comprises a modified corn starch, a modified wheat starch, a modified tapioca starch, a modified potato starch, or any combination thereof.

3. The tortilla shell of claim 1, wherein the soluble fiber comprises soluble corn fiber.

4. The tortilla shell of claim 1, wherein at least 25% by weight of the particles of the fine corn bran pass through a #200 mesh sieve.

5. The tortilla shell of claim 1, comprising a coarse corn bran in an amount of up to about 20% by dry weight of the tortilla shell, the coarse corn bran comprising particles, wherein at least 70% by weight of the particles of the coarse corn bran are retained on a #100 mesh sieve.

6. The tortilla shell of claim 5, wherein at least 50% by weight of the particles of the coarse corn bran are retained on a #80 mesh sieve.

7. The tortilla shell of claim 5, wherein the coarse corn bran is included in an amount of at least 5% by dry weight of the tortilla shell.

8. The tortilla shell of claim 1, comprising:
a. the RS4 ingredient in an amount of about 28% to about 38% by dry weight of the tortilla shell;
b. the soluble corn fiber in an amount of about 7% to about 10% by dry weight of the tortilla shell;
c. the fine corn bran in an amount of about 30% to about 45% by dry weight of the tortilla shell;
d. the corn masa in an amount of about 13% to about 20% by dry weight of the tortilla shell;
e. the net carbohydrate content of about 15% to about 24% by weight of the tortilla shell;
f. the oil in an amount of about 18% to about 22% by weight; and
g. the moisture content of about 4% to about 10% by weight of the tortilla shell.

9. The tortilla shell of claim 1, wherein the tortilla shell is gluten-free.

10. The tortilla shell of claim 1, comprising a fold support composition in an amount of up to 5% by dry weight of the tortilla shell, the fold support composition including:
a. a pregelatinized starch source in an amount of up to 4% by dry weight of the tortilla shell;
b. xanthan gum in an amount of up to 3% by dry weight of the tortilla shell; and/or
c. carboxymethylcellulose in an amount of up to 2% by dry weight of the tortilla shell.

11. The tortilla shell of claim 1, wherein the tortilla shell consists of:
a. RS4 ingredient;
b. soluble corn fiber;
c. fine corn bran;
d. corn masa;
e. oil;
f. flavorant in an amount of up to 3% by dry weight of the tortilla shell;
g. the fold support composition; and
h. moisture in an amount of up to 11%.

12. A method of making a shelf stable tortilla shell, comprising:
a. providing a dough, the dough comprising:
i. a type 4 resistant starch (RS4) ingredient in an amount of about 20% to about 40% by dry weight of the dough, the RS4 ingredient having an RS4 content of at least 75% by weight of the RS4 ingredient;
ii. a soluble fiber in an amount of about 5% to about 20% by dry weight of the dough;
iii. a fine corn bran in an amount of about 22% to about 52% by dry weight of the dough, the fine corn bran comprising particles, wherein at least 80% by weight of the particles of the fine corn bran pass through a #100 mesh sieve;
iv. corn masa in an amount of about 13% to about 25% by dry weight of the dough; and
v. water in an amount of about 40% to about 55% by weight of the dough;
b. forming the dough into a sheet; and
c. cooking the sheet to a moisture of about 3% to about 11% by weight of the sheet to form the tortilla shell, wherein the tortilla shell has a net carbohydrate content of less than 25% by weight of the tortilla shell.

13. The method of claim 12, wherein the sheet is cooked to an intermediate moisture of from about 20% to about 35% by weight.

14. The method of claim 13, wherein the cooking step comprises baking the sheet.

15. The method of claim 12, wherein the cooking comprises frying the sheet.

16. The method of claim 14, wherein the tortilla shell constitutes a hard taco shell, a tostada shell or a chip.

17. The method of claim 12, wherein the water has a temperature of about 25° C. (77° F.) to about 55° C. (131° F.).

18. (canceled)

19. The method of claim 12, comprising gelatinizing at least a portion of a starch content in the fine corn bran.

20. The method of claim 19, wherein the step of gelatinizing is performed at a temperature of at least 87.8° C. (190° F.).

21. The method of claim 12 wherein the dough comprises a fold support composition in an amount of up to 5% by dry weight of the dough, the fold support composition including:
a. a pregelatinized starch source in an amount of up to 4% by dry weight of the dough;
b. xanthan gum in an amount of up to 3% by dry weight of the dough; and/or
c. carboxymethylcellulose in an amount of up to 2% by dry weight of the dough.
